(19) United States
(12) Patent Application Publication
(10) Pub. No.: US 2025/0015419 A1
(43) Pub. Date: Jan. 9, 2025

(54) ELECTROCHEMICAL APPARATUS AND ELECTRIC DEVICE

(71) Applicant: Ningde Amperex Technology Limited, Ningde (CN)

(72) Inventors: Shaojiang LAO, Ningde (CN); Shaojun HUANG, Ningde (CN)

(73) Assignee: Ningde Amperex Technology Limited, Ningde (CN)

(21) Appl. No.: 18/894,118

(22) Filed: Sep. 24, 2024

Related U.S. Application Data
(63) Continuation of application No. PCT/CN2022/082793, filed on Mar. 24, 2022.

(51) Int. Cl. H01M 50/262; H01M 50/242

(52) U.S. Cl. CPC H01M 50/262; H01M 50/242

(57) ABSTRACT

An electrochemical apparatus includes: a housing, an electrode assembly, and a first adhesive portion. The electrode assembly is disposed within the housing, and the first adhesive portion is disposed on an outer surface of the housing, where a contact angle of a surface of the first adhesive portion facing away from the housing is greater than 105°. The electrochemical apparatus in is less prone to damage.

### CROSS REFERENCE TO THE RELATED APPLICATIONS

This application is a continuation application of International Application No. PCT/CN2022/082793, filed on Mar. 24, 2022, the contents of which are incorporated herein by reference in its entirety.

### TECHNICAL FIELD

Some embodiments of this application relate to the field of electrochemical technologies, and particularly to an electrochemical apparatus and an electric device.

### BACKGROUND

Secondary batteries have many advantages such as high specific energy density, long cycle life, high nominal voltage, low self-discharge rate, small size, and light weight, and therefore are widely used in the field of new energy. In recent years, with the rapid development of tablets, mobile phones, electric vehicles, and energy storage devices, and due to the continuous development of the new energy industry, secondary batteries have become increasingly important, and the market demand for secondary batteries has also increased.

In related art, the secondary battery includes an electrode assembly. A housing encloses around the electrode assembly to form the secondary battery. In this type of secondary battery, the electrode assembly often has edges and corners, and there is a certain amount of movement space within the housing. When the secondary battery is mounted in an electric device for use, the outer surface of the housing needs to be adhered to the electric device. During the use of the electric device, the electric device often moves significantly, causing the electrode assembly inside the secondary battery to move relative to the housing, causing the electrode assembly to collide with the housing. Over time, this is likely to damage the housing on corresponding positions, and in turn is likely to cause damage to the secondary battery and pose safety risks to the user in using the secondary battery.

### SUMMARY

In view of this, some embodiments of this application provide an electrochemical apparatus and an electric device to at least partially solve the foregoing problems.

According to an aspect of these embodiments of this application, an electrochemical apparatus is provided, including: a housing, an electrode assembly, and a first adhesive portion; the electrode assembly is disposed within the housing, and the first adhesive portion is disposed on an outer surface of the housing, where a contact angle of a surface of the first adhesive portion facing away from the housing is greater than 105°.

In some optional embodiments, at least one corner of the outer surface of the housing is provided with the first adhesive portion.

In some optional embodiments, 2 to 4 corners of the outer surface of the housing are each provided with the first adhesive portion.

In some optional embodiments, the first adhesive portion is a coating structure.

In some optional embodiments, the first adhesive portion is made of a material including at least one of silicon oxide, polysiloxane, or polytetrafluoroethylene.

In some optional embodiments, a cross-sectional shape of each of the first adhesive portions is one of a rectangle, a sector, a triangle, a trapezoid, a square, a closed figure formed by two tangents of a circle and an arc of the circle, or an n-sided polygon (n≥5).

In some optional embodiments, each of the first adhesive portions has a same cross-sectional shape.

In some optional embodiments, at least two sides of each of the first adhesive portions have equal lengths.

In some optional embodiments, at least one side of each of the first adhesive portions fits with an edge of the outer surface of the housing.

In some optional embodiments, two sides of each of the first adhesive portions fit with edges of the outer surface of the housing.

In some optional embodiments, when the cross-sectional shape of the first adhesive portion is a sector or the closed figure, a radius R of the sector or the arc of the closed figure satisfies: if W<L, 0.05 W≤R≤0.35 W; and if W>L, 0.05 L≤R≤0.35 L; where W is the width of the housing, and L is the length of the housing.

In some optional embodiments, when the cross-sectional shape of the first adhesive portion is a rectangle, a triangle, a trapezoid, or an n-sided polygon (n≥5), side lengths d1 and d2 of two sides of the first adhesive portion fitting with the edges of the outer surface of the housing respectively satisfy: 0.05 W≤d1≤0.35 W and 0.05 L≤d2≤0.35 L; or 0.05 L≤d1≤0.35 L and 0.05 W≤d2≤0.35 W; where W is the width of the housing, and L is the length of the housing.

In some optional embodiments, when the first adhesive portion is affixed to an electric device, a first peel strength between the first adhesive portion and the electric device is less than a second peel strength between the first adhesive portion and the outer surface of the housing.

In some optional embodiments, the electric device includes a second adhesive portion, and when the first adhesive portion is adhered to the second adhesive portion, a third peel strength between the second adhesive portion and the first adhesive portion is less than the second peel strength.

In some optional embodiments, the first peel strength or the third peel strength is less than 180 gf/25 mm.

According to another aspect of this application, an electric device is further provided, the electric device including a device body and the foregoing electrochemical apparatus, where the electrochemical apparatus is configured to supply power to the device body.

The electrochemical apparatus and the electric device are provided in some embodiments of this application. Since the outer surface of the housing of the electrochemical apparatus is provided with the first adhesive portion, and the contact angle of the surface of the first adhesive portion facing away from the housing is greater than 105°, when the housing of the electrochemical apparatus in some embodiments of this application is fixed to the electric device, at least a part of the housing is less likely to be adhered by the electric device or its adhesive structure due to the presence of the first adhesive portion, so that when the electrode assembly moves relative to the housing, that part of the housing can undergo partial deformation with the movement of the electrode assembly. In this way, the impact of the electrode assembly on that part of the housing is buffered to some extent, thereby reducing the impact of the electrode assembly on that part of the housing (for example, corners), so that the housing is less prone to damage, and thus the electrochemical apparatus is also less prone to damage, thereby effectively extending the service life of the electrochemical apparatus and reducing the safety risk to the user in using the electrochemical apparatus (including but not limited to the lithium-ion battery or sodium-ion battery).

### BRIEF DESCRIPTION OF DRAWINGS

To more clearly illustrate the technical solutions of some embodiments of this application, the following briefly describes the accompanying drawings required in this application. Apparently, the accompanying drawings in the following descriptions show only some embodiments recorded in this application, and persons of ordinary skill in the art can derive others drawings based on these accompanying drawings.

FIG. 1 is a schematic structural diagram of an optional electrochemical apparatus according to an embodiment of this application.

FIG. 2 is a schematic diagram of a contact angle of a surface of a first adhesive portion facing away from a housing according to an embodiment of this application.

FIG. 3 is a schematic structural diagram of a second adhesive portion on an optional electric device according to an embodiment of this application.

FIG. 4 is a schematic structural diagram of a second adhesive portion on another optional electric device according to an embodiment of this application.

FIG. 5 is a schematic structural diagram of a second adhesive portion on yet another optional electric device according to an embodiment of this application.

FIG. 6 is a schematic structural diagram of a second adhesive portion on yet another optional electric device according to an embodiment of this application.

FIG. 7 is a schematic structural diagram of a second adhesive portion on yet another optional electric device according to an embodiment of this application.

FIG. 8 is a schematic diagram of a cross-sectional shape of an optional first adhesive portion according to an embodiment of this application.

FIG. 9 is a schematic diagram of a cross-sectional shape of another optional first adhesive portion according to an embodiment of this application.

FIG. 10 is a schematic diagram of a cross-sectional shape of yet another optional first adhesive portion according to an embodiment of this application.

FIG. 11 is a schematic diagram of a cross-sectional shape of yet another optional first adhesive portion according to an embodiment of this application.

FIG. 12 is a schematic diagram of a cross-sectional shape of yet another optional first adhesive portion according to an embodiment of this application.

FIG. 13 is a schematic diagram of a cross-sectional shape of yet another optional first adhesive portion according to an embodiment of this application.

FIG. 14 is a schematic diagram of a position of a second adhesive portion at an angle according to an embodiment of this application.

FIG. 15 is a schematic diagram of movement between an electrode assembly and a housing of an electrochemical apparatus according to the prior art.

FIG. 16 is a schematic diagram of movement between an electrode assembly and a housing of an optional electrochemical apparatus according to an embodiment of this application.

FIG. 17 is a schematic diagram of an optional electric device according to an embodiment of this application.

### DETAILED DESCRIPTION

To make persons skilled in the art understand the technical solutions in this application better, the following clearly and in detail describes the technical solutions in some embodiments of this application with reference to the accompanying drawings in some embodiments of this application. Apparently, the described embodiments are some rather than all embodiments of this application. All other embodiments obtained by persons of ordinary skill in the art based on some embodiments of this application shall fall within the protection scope of some embodiments of this application.

The following describes specific implementations of some embodiments of this application with reference to the accompanying drawings.

It should be noted that secondary batteries (chargeable batteries) may include nickel metal hydride batteries, nickel-cadmium batteries, lead-acid (or lead storage) batteries, lithium-ion batteries, sodium-ion batteries, polymer lithium-ion batteries, and the like. In the context of some embodiments of this application, the lithium-ion battery is used as an example of an electrochemical apparatus to explain this application. However, as mentioned above, the electrochemical apparatus of this application is not limited to the lithium-ion battery and, for example, may alternatively be the sodium-ion battery or the like.

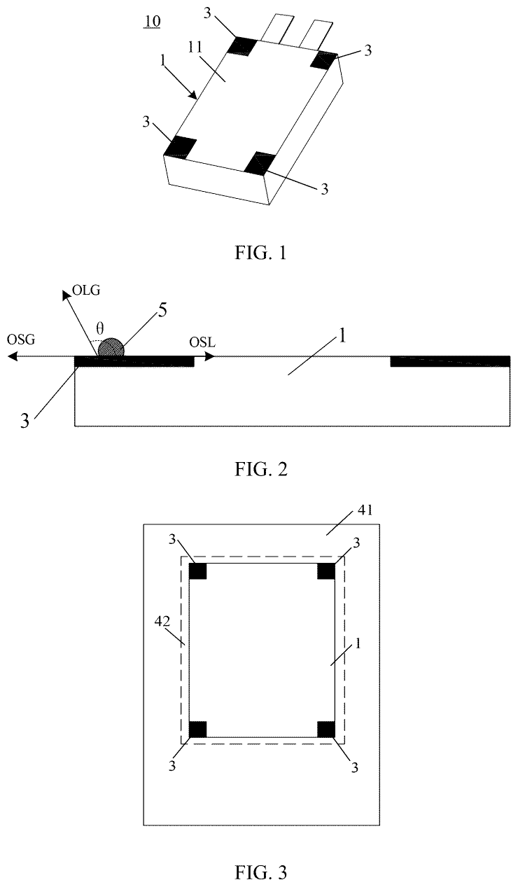

According to an aspect of these embodiments of this application, as shown in FIG. 1 to FIG. 17, an embodiment of this application provides an electrochemical apparatus 10. The electrochemical apparatus 10 includes: a housing 1, an electrode assembly 2, and a first adhesive portion 3. The electrode assembly 2 is disposed within the housing 1, and the first adhesive portion 3 is disposed on an outer surface 11 of the housing 1, where a contact angle of a surface of the first adhesive portion 3 facing away from the housing 1 is greater than 105°.

In these embodiment of this application, since the outer surface 11 of the housing 1 of the electrochemical apparatus 10 is provided with the first adhesive portion 3, and the contact angle of the surface of the first adhesive portion 3 facing away from the housing 1 is greater than 105°, when the housing 1 of the electrochemical apparatus 10 in this embodiment of this application is fixed to an electric device, at least a part of the housing 1 is less likely to be adhered by the electric device or the adhesive structure on the electric device due to the presence of the first adhesive portion 3, so that when the electrode assembly 2 moves relative to the housing 1, that part of the housing 1 can undergo partial deformation with the movement of the electrode assembly 2. In this way, the impact of the electrode assembly 2 on that part of the housing 1 is buffered to some extent, thereby reducing the impact of the electrode assembly 2 on that part of the housing 1, so that the housing 1 is less prone to damage, and thus the electrochemical apparatus 10 is also less prone to damage, thereby effectively extending the service life of the electrochemical apparatus and reducing the safety risk to the user in using the electrochemical apparatus (including but not limited to the lithium-ion battery or sodium-ion battery).

The following is a specific description of the electrochemical apparatus 10 in some embodiments of this application. It can be understood that the description below should not be construed as any limitation of these embodiments of this application.

In these embodiments of this application, the housing 1 is not limited in material and can generally be made of metal. For example, in some optional electrochemical apparatus 10 of this application, the housing 1 is made of metal plastic film, and in some examples thereof, the housing 1 is made of aluminum plastic film or steel plastic film. In addition, the housing 1 is also not limited in shape in these embodiments of this application. For example, the housing 1 can be cuboid-shaped or approximately cuboid-shaped (or a cross-section of the housing 1 in one direction can be rectangular or approximately rectangular in shape). As shown in FIG. 1, the housing 1 is generally a cuboid. To facilitate the description of these embodiments of this application, such a housing is used as an example below.

In these embodiments of this application, the electrode assembly 2 is not limited in its specific structure. For example, the electrode assembly 2 may include a positive electrode plate, a separator, a negative electrode plate, an electrolyte, a positive electrode tab connected to the positive electrode plate, and a negative electrode tab connected to the negative electrode plate. For the electrochemical apparatus 10, the positive electrode tab is used to lead out the positive electrode of the electrochemical apparatus 10 from the positive electrode plate, and the negative electrode tab is used to lead out the negative electrode of the electrochemical apparatus 10 from the negative electrode plate. In this example, the positive electrode plate, separator, and negative electrode plate of the electrode assembly 2 may be wound, or may be stacked, and this is not limited in these embodiments of this application. In these embodiments of this application, the electrode assembly 2 is disposed within the housing 1, and there is a certain gap between the electrode assembly 2 and the housing 1, so that the electrode assembly 2 can move relative to the housing 1 within the housing 1.

In these embodiments of this application, the first adhesive portion 3 is not limited to any specific structure and can be a structure fixedly connected to the outer surface of the housing 1 (for example, the fixed connection method may be bonding, welding, or the like), and the contact angle θ of the surface of the first adhesive portion 3 facing away from the housing 1 is greater than 105°.

In related art, the contact angle θ is also called a wetting angle. Reference is made to FIG. 2 for understanding. A shape shown in the figure is formed when a liquid drop 5 (the size in FIG. 2 is only used as an example) is dropped on a solid surface (corresponding to the surface of the first adhesive portion 3 facing away from the housing 1 in FIG. 2), and a contact angle θ is defined as follows: Let, at a solid-liquid-gas three-phase interface, the solid-gas interfacial tension be OSG, the solid-liquid interfacial tension be OSL, and the gas-liquid surface tension be OLG, then the contact angle θ is an included angle at the three-phase boundary through the interior of the liquid to the gas-liquid interface, and the three-phase interfacial tension generally follows Young's equation: OSG=OSL+OLGcos θ. Generally speaking, the magnitude of the contact angle θ is a criterion for evaluating wettability. If θ=0°, cos θ=1, the liquid completely wets the solid surface, and the liquid spreads on the solid surface; if 0°<θ<90°, the liquid may wet the solid, and a smaller θ indicates better wettability; if 90°<θ<180°, the liquid does not wet the solid; and if θ=180°, the solid does not wet at all, and the liquid gathers into small balls on the solid surface. In general, a larger contact angle θ indicates that the liquid is less likely to wet the surface, the surface is more hydrophobic, and the surface has less adhesion.

The contact angle θ can be calculated and measured using an included angle between a tangent to the liquid surface at a contact point between the liquid drop and the solid surface and a tangent to the solid surface. It can be understood that the contact angle θ can be measured by various measurement methods, such as the tangent method, the width-height method, the ellipse method, and the Laplace-Young method. The specific method can be chosen based on the relevant technical technologies, and is not limited herein. In an optional example, the contact angle can be measured as follows: dropping a liquid drop onto a solid surface (corresponding to the surface of the first adhesive portion 3 facing away from the housing 1 in FIG. 2) to form a shape shown in FIG. 2, and taking an image of the liquid drop and solid surface from the perspective in FIG. 2 (which can be understood as the perspective along the direction parallel to the solid surface); then determining a baseline in the image, where the baseline can be a line connecting the boundary between the solid surface and the liquid drop and a line connecting two three-phase points (that is, intersection points of the solid-liquid-gas three-phase interface); and determining the profile of the liquid drop, fitting the profile curve of the liquid drop using an appropriate method, and then calculating a contact angle θ, where the fitting method can be, for example, to divide the contour of the liquid drop into multiple small segments, and fit each small segment, so as to be able to maximize the approximation to the true profile of the liquid drop, to obtain better measurement results. Alternatively, in other measurement methods, the contact angle θ can be measured using existing specialized contact angle measuring machines. This is not specifically limited in these embodiments of this application.

It should be noted that the position, shape, and thickness of the first adhesive portion 3 in FIG. 2 are only for illustration, and should not be construed as any limitation on these embodiments of this application.

Since the component providing bonding capability in the adhesive structure on the electric device is actually an adhesive liquid, and the contact angle θ of the surface of the first adhesive portion 3 facing away from the housing 1 in these embodiments of this application is greater than 105°, when the housing 1 of the electrochemical apparatus 10 is fixed to an electric device, at least a part of the housing 1 is less likely to be adhered by the adhesive structure on the electric device due to the presence of the first adhesive portion 3.

In some embodiments, the contact angle θ of the surface of the first adhesive portion 3 facing away from the housing 1 is 120°-180°. In other embodiments, the contact angle θ is 150°-180°. As the contact angle θ increases, the adhesion of the surface of the first adhesive portion 3 decreases. This can further reduce the impact of the electrode assembly 2 on the housing 1 (for example, at the corners), further improving the service life of the electrochemical apparatus.

In some optional embodiments, when the first adhesive portion 3 is affixed to an electric device 4, a first peel strength between the first adhesive portion 3 and the electric device 4 is less than a second peel strength between the first adhesive portion 3 and the outer surface 11 of the housing 1.

Peel strength refers to the maximum load required per unit width to separate two adhered materials under specified peeling conditions. The first peel strength can indicate the adhesion strength between the first adhesive portion 3 and the electric device 4, and the second peel strength can indicate the adhesion strength between the first adhesive portion 3 and the outer surface 11 of the housing 1.

In these optional embodiments, the housing 1 is adhered to the electric device 4 through the first adhesive portion 3, and the first peel strength between the first adhesive portion 3 and the electric device 4 is less than the second peel strength between the first adhesive portion 3 and the outer surface 11 of the housing 1, so that on the basis that the electrochemical apparatus 10 can be stably mounted on the electric device 4, when the electrode assembly 2 within the housing 1 moves relative to the housing 1, the housing 1 can move to some extent relative to the electric device 4 together with the movement of the electrode assembly 2 due to the presence of the first adhesive portion 3, without being easily hindered. In this way, the impact of the electrode assembly 2 on the housing 1 is buffered to some extent, thereby reducing the impact of the electrode assembly 2 on the housing, so that the housing 1 is less prone to damage.

In some optional embodiments, the electric device 4 includes a second adhesive portion 42. When the first adhesive portion 3 is adhered to the second adhesive portion 42, a third peel strength between the second adhesive portion 42 and the first adhesive portion 3 is less than the second peel strength.

Like the first peel strength and the second peel strength, the third peel strength can indicate the adhesion strength between the second adhesive portion 42 and the first adhesive portion 3.

In these optional embodiments, the second adhesive portion 42 can be the foregoing adhesive structure on the electric device, the housing 1 and the first adhesive portion 3 are adhered to the second adhesive portion 42 of the electric device 4, the third peel strength between the second adhesive portion 42 and the first adhesive portion 3 is less than the second peel strength between the first adhesive portion 3 and the outer surface 11 of the housing 1, so that on the basis that the electrochemical apparatus 10 can be stably mounted on the electric device 4, when the electrode assembly 2 within the housing 1 moves relative to the housing 1, that part of the housing 1 corresponding to the position of the first adhesive portion 3 is less likely to be adhered by the second adhesive portion 42 on the electric device 4 due to the presence of the first adhesive portion 3, and when the electrode assembly 2 moves relative to the housing 1, that part of the housing 1 can undergo partial deformation with the movement of the electrode assembly 2. In this way, the impact of the electrode assembly 2 on that part of the housing 1 is buffered to some extent, thereby reducing the impact of the electrode assembly 2 on that part of the housing 1, so that the housing 1 is less prone to damage, and thus the electrochemical apparatus 10 is also less prone to damage, thereby effectively extending the service life of the electrochemical apparatus and reducing the safety risk to the user in using the electrochemical apparatus (including but not limited to the lithium-ion battery or sodium-ion battery).

In some optional embodiments, the first peel strength or the third peel strength is less than 180 gf/25 mm. When the first peel strength or the third peel strength is less than this value, it can effectively ensure that when the electrode assembly 2 moves relative to the housing 1, the housing 1 can undergo partial deformation with the movement of the electrode assembly 2. In this way, the impact of the electrode assembly 2 on the housing 1 is buffered to some extent. The testing methods for each peel strength in these embodiments of this application can use GB/T 2792-2014 “Measurement of peel adhesion properties for adhesive tapes”.

In some embodiments, the first peel strength or the third peel strength is 0 gf/25 mm-150 gf/25 mm. In other embodiments, the first peel strength or the third peel strength is 0 gf/25 mm-90 gf/25 mm. As the peel strength decreases, the adhesion of the surface of the first adhesive portion 3 also decreases. This can further reduce the impact of the electrode assembly 2 on the housing 1 (for example, at the corners), further improving the service life of the electrochemical apparatus.

In these embodiments of this application, one or more second adhesive portion 42 may be provided. For example, the second adhesive portion 42 may be one or more double-sided adhesives disposed on the electric device 4, with one side adhered to the electric device 4 and another side for adhering the first adhesive portion 3 and the outer surface 11 of the housing 1, to stably fix the electrochemical apparatus to the electric device 4. When there are multiple second adhesive portions 42, their sizes and shapes can differ from each other, provided that they meet the requirements. This is not limited in these embodiments of this application.

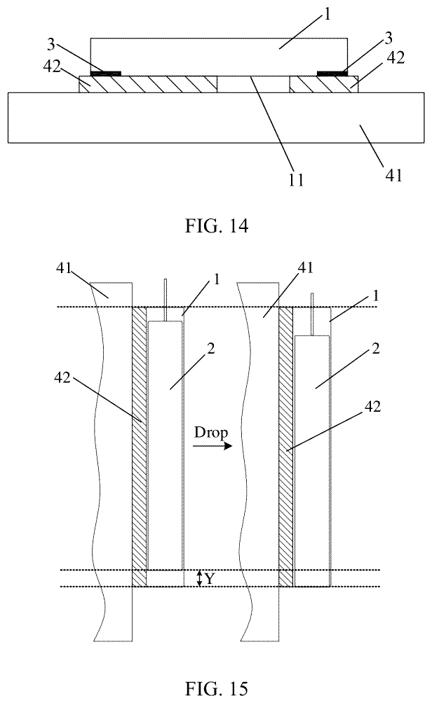

Referring to the examples in FIG. 3 to FIG. 7 showing schematics of the second adhesive portion 42 of different sizes and shapes in different positions, it can be understood that the second adhesive portion 42 schematically shown in dashed lines in FIG. 3 to FIG. 7 is to facilitate showing the positions of the second adhesive portions 42 between the device body 41 of the electric device 4 and the housing 1, and this can be further understood in conjunction with FIG. 14 showing the positions of the second adhesive portion 42 between the device body 41 of the electric device 4 and the housing 1. FIG. 3 to FIG. 7 and FIG. 14 are only for the purpose of facilitating the understanding of these embodiments of this application and should not be construed as any limitation on this application.

In some optional embodiments, at least one corner of the outer surface 11 of the housing 1 of the electrochemical apparatus 10 in these embodiments of this application is provided with the first adhesive portion 3.

In these embodiments of this application, a corner of the outer surface 11 of the housing 1 refers to a region near an intersection between adjacent sides of the outer surface 11 of the housing 1. The corner is referred to because an angle is formed between two adjacent sides. Taking the electrochemical apparatus 10 in FIG. 1 as an example, the housing 1 is generally cuboid-shaped, the outer surface 11 of the housing 1 is rectangular, so it has 4 corners, and the 4 corners are located near the intersections of each adjacent two sides of the rectangle.

Since the edges and corners on the electrode assembly 2 of the electrochemical apparatus 10 (to be specific, the stress concentration positions on the electrode assembly 2) are generally distributed near the corners of the electrode assembly 2 and are covered by the corresponding corners of the outer surface 11 of the housing 1, when the corners of the outer surface 11 of the housing 1 are adhered by the adhesive structure of the electric device 4 (such as the foregoing second adhesive structure 42), the housing 1 cannot deform due to the adhesion effect. In this case, when the electrode assembly 2 within the housing 1 moves relative to the housing 1, each electrode assembly 2 is more likely to impact the regions near the corners of the housing 1, and this is more likely to cause damage to the regions near the corners of the housing 1 over time.

Therefore, at least one corner of the outer surface 11 of the housing 1 of the electrochemical apparatus 10 in these embodiments of this application is provided with the first adhesive portion 3, and the contact angle of the surface of the first adhesive portion 3 facing away from the housing 1 is greater than 105°, so that when the housing 1 of the electrochemical apparatus 10 is fixed to the electric device, at least one corner of the housing 1 is less likely to be adhered by the second adhesive portion 42 (that is, the foregoing adhesive structure) on the electric device 4 due to the presence of the first adhesive portion 3, the second adhesive portion 42 is less likely to constrain and hinder the deformation of the housing 1. When the electrode assembly 2 moves relative to the housing 1, the housing 1 can undergo partial deformation with the movement of the electrode assembly 2. In this way, the impact of the electrode assembly 2 on the corners of the housing 1 is buffered to some extent, thereby reducing the impact of the electrode assembly 2 on the corners of the housing 1, so that the housing 1 is less prone to damage, and thus the electrochemical apparatus 10 is also less prone to damage, thereby effectively extending the service life of the electrochemical apparatus 10 and reducing the safety risk to the user in using the electrochemical apparatus (including but not limited to the lithium-ion battery or sodium-ion battery).

In some optional embodiments, 2 to 4 corners of the outer surface 11 of the housing 1 are each provided with the first adhesive portion 3. Obviously, the outer surface 11 of the housing 1 generally does not have only one corner, therefore, in this application, 2 to 4 corners of the outer surface 11 of the housing 1 are each provided with the first adhesive portion 3, and this can provide more comprehensive protection to the housing 1 and prevents damage to the housing 1 of the electrochemical apparatus 10.

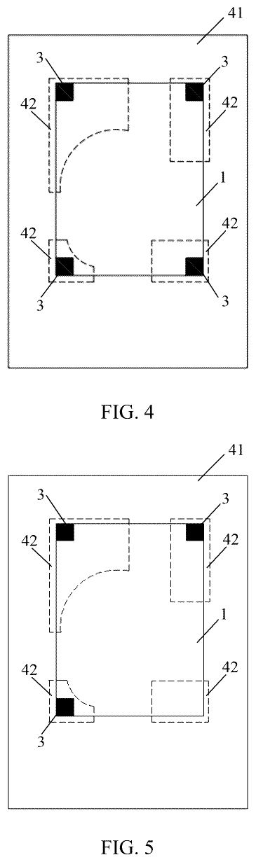

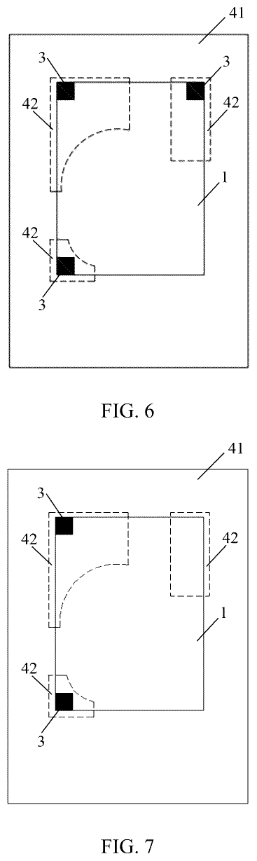

With reference to FIG. 7, it can be understood that the figure shows an example in which 2 corners of the outer surface 11 of the housing 1 are each provided with the first adhesive portion 3. With reference to FIG. 5 and FIG. 6, it can be understood that the figures show examples in which 3 corners of the outer surface 11 of the housing 1 are each provided with the first adhesive portion 3. With reference to FIG. 3 and FIG. 4, it can be understood that the figures show examples in which 4 corners of the outer surface 11 of the housing 1 are each provided with the first adhesive portion 3. However, it can be understood that these examples should not be construed as any limitation on this application.

In some optional embodiments, the first adhesive portion 3 is a coating structure. The first adhesive portion 3 in the form of a coating can be more stably disposed on the outer surface of the housing 1 and does not take up too much volume. This is conducive to reducing the volume and weight of the electrochemical apparatus. In addition, compared to other structural forms, the first adhesive portion 3 in the form of a coating structure apparently causes less damage to the housing 1 and makes the production process of the electrochemical apparatus 10 simpler.

In addition, the first adhesive portion 3 shown in FIG. 3 to FIG. 7 and FIG. 14 can be a coating structure. Of course, this should not be construed as any limitation on these embodiments of this application.

In some optional embodiments, the first adhesive portion 3 is made of a material including at least one of silicon oxide, polysiloxane, or polytetrafluoroethylene. Taking the first adhesive portion 3 being a coating structure as an example, that is, the first adhesive portion 3 may be a silicon oxide coating, a polysiloxane coating, a polytetrafluoroethylene coating, or a mixed coating of two or three of silicon oxide, polysiloxane, and polytetrafluoroethylene. When the first adhesive portion 3 made of these materials is disposed on the outer surface of the housing 1, a contact angle θ of a surface of the first adhesive portion 3 facing away from the housing 1 is greater than 105°, meeting the usage requirements.

In some optional embodiments, a cross-sectional shape of each of the first adhesive portions 3 is one of a rectangle, a sector, a triangle, a trapezoid, a closed figure formed by two tangents of a circle and an arc of the circle, or an n-sided polygon (n≥5). Various cross-sectional shapes of the first adhesive portion 3 are provided in these embodiments of this application to meet the needs of different shapes of the housing 1 and provide more options for the preparation of electrochemical apparatuses.

In these embodiments of this application, the cross-section of the first adhesive portion 3 may be a cross-section along a direction perpendicular to the outer surface 11 of the housing 1. Taking the first adhesive portion 3 being a coating structure as an example, the cross-section of the first adhesive portion 3 in the direction perpendicular to the outer surface 11 of the housing 1 is the cross-section in the thickness direction of the coating.

When the cross-sectional shape of the first adhesive portion 3 is a rectangle, it can be a square, that is, the length and width of the rectangle are equal. When the cross-sectional shape of the first adhesive portion 3 is a trapezoid, it can be a right-angle trapezoid. When the cross-sectional shape of the first adhesive portion 3 is an n-sided polygon (n≥5), it can have at least one right angle.

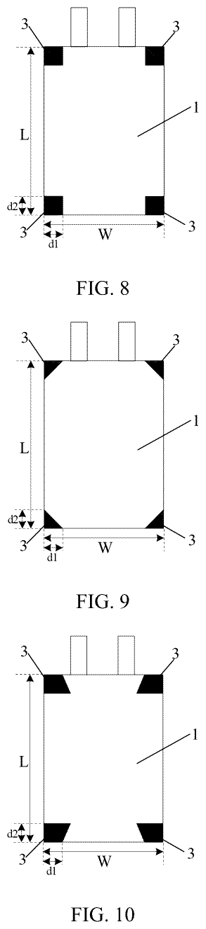

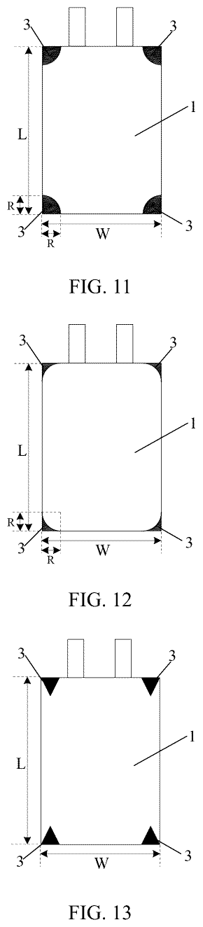

In some optional embodiments, each of the first adhesive portions 3 has a same cross-sectional shape. Referring to FIG. 8 to FIG. 13, the figures show examples in which each of the first adhesive portions 3 has a same cross-sectional shape, where the cross-section of each of the first adhesive portions 3 in FIG. 8 is a rectangle of the same shape; each of the first adhesive portions 3 in FIG. 9 and FIG. 13 has a cross-section of the same shape in the form of a triangle (for example, a right-angle triangle in FIG. 9 and an acute-angle triangle in FIG. 13); each of the first adhesive portions 3 in FIG. 10 has a cross-section of the same shape in the form of a trapezoid (a right-angle trapezoid in FIG. 10); each of the first adhesive portions 3 in FIG. 11 has a cross-section of the same shape in the form of a sector; and each of the first adhesive portions 3 in FIG. 12 has a cross-section in the form of a closed figure formed by two tangents of the same shape of a circle and an arc of the circle. In addition, the first adhesive portion 3 shown in FIG. 8 to FIG. 13 is a coating structure. Of course, this should not be construed as any limitation on these embodiments of this application.

In some optional embodiments, at least two sides of each of the first adhesive portions 3 have equal lengths. Still referring to FIG. 8 to FIG. 13, the figures also show some such examples.

In some optional embodiments, at least one side of each of the first adhesive portions 3 fits with an edge of the outer surface 11 of the housing 1. Since at least one side of the first adhesive portion 3 in these embodiments of this application fits with an edge of the outer surface 11 of the housing 1, when the electrode assembly 2 inside the housing 1 moves relative to the housing 1, edges of the outer surface 11 of the housing are less likely to be adhered by the adhesive structure on the electric device 4 (such as the foregoing second adhesive portion 42), and the adhesive structure is less likely to hinder the deformation of the housing 1. When the electrode assembly 2 moves relative to the housing 1, the housing 1 can undergo partial deformation with the movement of the electrode assembly 2. In this way, the impact of the electrode assembly 2 on the housing 1 is buffered to some extent, thereby reducing the impact of the electrode assembly 2 on the housing 1, so that the housing 1 is less prone to damage. With reference to FIG. 8 to FIG. 13, it can be understood that the figures also show such examples, where the cross-sectional shape of the first adhesive portion 3 in FIG. 13 is a triangle, with one side fitting with an edge of the outer surface 11 of the housing 1.

In some optional embodiments, two sides of each of the first adhesive portions 3 fit with edges of the outer surface 11 of the housing 1. With reference to FIG. 8 to FIG. 12, it can be understood that the figures also show such examples.

In some optional embodiments, the outer surface 11 of the housing 1 is a rectangle. When the cross-sectional shape of the first adhesive portion 3 is a rectangle, a triangle, a trapezoid, or an n-sided polygon (n≥5), the side lengths d1 and d2 of the two sides of the first adhesive portion 3 fitting with the edges of the outer surface 11 of the housing 1 respectively satisfy: 0.05 W≤d1≤0.35 W and 0.05 L≤d2≤0.35 L; or, 0.05 L≤d1≤0.35 L and 0.05 W≤d2≤0.35 W; where W is the width of the housing 1, and L is the length of the housing 1.

In some preferred embodiments, when the cross-sectional shape of the first adhesive portion 3 is a rectangle, a triangle, a trapezoid, or an n-sided polygon (n≥5), the side lengths d1 and d2 of the two sides of the first adhesive portion 3 fitting with the edges of the outer surface 11 of the housing 1 respectively satisfy: 0.05 W≤d1≤0.25 W and 0.05 L≤d2≤0.25 L; or 0.05 L≤d1≤0.25 L and 0.05 W≤d2≤0.25 W; where W is the width of the housing 1, and L is the length of the housing 1. This can ensure the mounting stability of the electrochemical apparatus and meet the requirements.

In some more preferred embodiments, when the cross-sectional shape of the first adhesive portion 3 is a rectangle, a triangle, a trapezoid, or an n-sided polygon (n≥5), the side lengths d1 and d2 of the two sides of the first adhesive portion 3 fitting with the edges of the outer surface 11 of the housing 1 respectively satisfy: 0.1 W≤d1≤0.25 W and 0.1 L≤d2≤0.25 L; or 0.1 L≤d1≤0.25 L and 0.1 W≤d2≤0.25 W, where W is the width of the housing 1, and L is the length of the housing 1. This can better ensure the mounting stability of the electrochemical apparatus and meet the requirements.

For cases in which the cross-sectional shape of the first adhesive portion 3 is a rectangle, a triangle, or a trapezoid, reference can be made to FIG. 8, FIG. 9, and FIG. 10 for understanding. Details are not repeated herein.

In a simple example of this more preferred embodiment, if W is 20 mm and L is 30 mm, d1 and d2 can respectively satisfy: 2 mm≤d1≤5 mm and 3 mm≤d2≤7.5 mm; or 3 mm≤d1≤7.5 mm and 2 mm≤d2≤5 mm.

In some optional embodiments, d1=d2, that is, side lengths of two sides of the first adhesive portion 3 fitting with the edges of the outer surface 11 of the housing 1 are equal. In such implementation, the cross-sectional shape of the first adhesive portion 3 can be a square (that is, a rectangle with equal length and width), an isosceles right triangle, a trapezoid or n-sided polygon (n≥5) with two equal perpendicular sides (the two perpendicular sides being the two sides of the first adhesive portion 3 fitting with the edges of the outer surface 11 of the housing 1).

Taking the d1 and d2 respectively satisfying: 2 mm≤d1≤5 mm and 3 mm≤d2≤7.5 mm; or 3 mm≤d1≤7.5 mm and 2 mm≤d2≤5 mm as an example, specifically, it may be that d1=d2=2 mm, 3 mm, 5 mm, or the like. Of course, these examples should not be construed as limitations on this application.

In some optional embodiments, the outer surface 11 of the housing 1 is a rectangle. When the cross-sectional shape of the first adhesive portion 3 is a sector or a closed figure formed by two tangents of the same shape of a circle and an arc, the radius R of the sector or the arc of the closed figure satisfies:
if W<L, 0.05 W≤R≤0.35 W; and if W>L, 0.05 L≤R≤0.35 L; where W is the width of the housing 1, and L is the length of the housing 1.

Reference is made to FIG. 11 and FIG. 12 respectively showing that the cross-sectional shape of the first adhesive portion 3 is a sector and that the cross-sectional shape of the first adhesive portion 3 is a closed figure formed by two tangents of the same shape of a circle and an arc.

In some of these preferred embodiments, when the cross-sectional shape of the first adhesive portion 3 is a sector or a closed figure formed by two tangents of a circle and an arc of the same shape, the radius R of the sector or the arc of the closed figure satisfies: if W<L, 0.05 W≤R≤0.25 W; and if W>L, 0.05 L≤R≤0.25 L; where W is the width of the housing 1, and L is the length of the housing 1. This can ensure the mounting stability of the electrochemical apparatus and meet the requirements.

In some of these more preferred embodiments, when the cross-sectional shape of the first adhesive portion 3 is a sector or a closed figure formed by two tangents of a circle and an arc of the same shape, the radius R of the sector or the arc of the closed figure satisfies: if W<L, 0.1 W≤R≤0.25 W; and if W>L, 0.1 L≤R≤0.25 L; where W is the width of the housing 1, and L is the length of the housing 1. This can better ensure the mounting stability of the electrochemical apparatus and meet the requirements.

In a simple example of this more preferred embodiment, if W is 20 mm and L is 30 mm, W<L, and 0.1 W=2 mm≤R≤5 mm=0.25 W; and if W is 30 mm and L is 20 mm, W>L, and 0.1 L=2 mm≤R≤5 mm=0.25 L. For example, R may specifically be 2 mm, 3 mm, 5 mm, or the like. Of course, these examples should not be construed as limitations on this application.

In some optional embodiments, when the cross-sectional shape of the first adhesive portions 3 is a sector, the circular angle of the sector is 90°.

In the following, an overall and easier-to-understand illustration of the principles, structures, and beneficial effects of the electrochemical apparatus in these embodiments of this application is provided by way of example, but it should be understood that the following examples should not be construed as any limitation on these embodiments of this application.

The following provides an example in which the housing 1 is made of aluminum plastic film or steel plastic film, having a cuboid shape, with the outer surface 11 being rectangular; the electrode assembly 2 is a wound electrode assembly; the first adhesive portion 3 is a coating structure; 4 first adhesive portions 3 are respectively located at 4 corners of the outer surface 11; and the second adhesive portion 42 on the electric device 4 is a double-sided adhesive.

First, referring to FIG. 15, a brief introduction is provided for the prior art solution without using the electrochemical apparatus 10 in this application. Referring to FIG. 15 showing an electrochemical apparatus 10 mounted on the device body 41 of the electric device 4 in a prior art solution, since 4 corners of the outer surface 11 of the housing 1 are all adhered and fixed by the second adhesive portion 42 (for example, double-sided adhesive) on the device body 41, there is a certain amount of movement space for the electrode assembly 2 within the housing. When the electric device 4 moves (for example, due to the electric device 4 falling, or being swung by the user during the use of the electric device), an entirety of the electrochemical apparatus 10 moves. When the entirety ends moving, the electrode assembly 2 continues to move relative to the housing 1 within the housing 1 due to inertia, and the housing 1 cannot move because the 4 corners of the outer surface 11 are fixed by the second adhesive portion 42 (referring to FIG. 15, in the process of the housing 1 falling, the electrode assembly 2 moved downward relative to the housing 1 by a distance of Y, and the housing 1 is constrained and hindered by the second adhesive portion 42 and cannot deform). Therefore, a relatively large impact by the electrode assembly 2 on the housing 1 is produced, and regions near the corners of the outer surface 11 of the housing 1 are likely to be damaged by the impact of the electrode assembly 2.

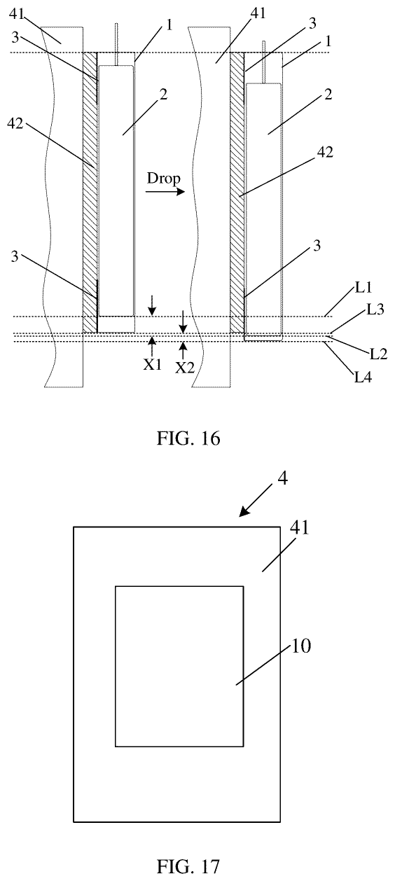

Then, referring to FIG. 16, a brief description of the solution for the electrochemical apparatus 10 in this application is given. Referring to FIG. 16, the electrochemical apparatus 10 is mounted on the device body 41 of the electric device 4 and is adhered and fixed by the second adhesive portion 42 (for example, double-sided adhesive) on the device body 41. The 4 corners of the outer surface 11 of the housing 1 of the electrochemical apparatus 10 are each provided with the first adhesive portion 3. The first adhesive portion 3 is a coating structure coated on the outer surface 11 of the housing 1, and a contact angle θ of the surface of the first adhesive portion 3 facing away from the housing 1 is greater than 105°. The first adhesive portion 3 is in contact with the second adhesive portion 42, and a peel strength (that is, the third peel strength) between the first adhesive portion 3 and the second adhesive portion 42 is less than a peel strength (that is, the second peel strength) between the housing 1 and the second adhesive portion 42, so that on the basis that the housing 1 can be stably adhered to the device body of the electric device 4 by the second adhesive portion 42, the 4 corners of the outer surface 11 of the housing 1 are separated from the second adhesive portion 42 by the first adhesive portion 3; and the 4 corners of the housing 1 are less likely to be adhered by the second adhesive portion 42. The second adhesive portion 42 is not to constrain and hinder the deformation of the housing 1, and when the electrode assembly 2 moves relative to the housing 1, that part of the housing 1 can undergo partial deformation with the movement of the electrode assembly 2 (referring to FIG. 16, during the housing 1 falling, the electrode assembly 2 moved downward relative to the housing 1 by a distance X1 (the distance between dashed lines L1 and L2), and that part of the housing 1 deformed relative to the electric device 4 by a distance X2 (the distance between dashed lines L3 and L4)). In this way, the impact of the electrode assembly 2 on that part of the housing 1 is buffered to some extent, thereby reducing the impact of the electrode assembly 2 on that part of the housing 1, so that the housing 1 is less prone to damage, and thus the electrochemical apparatus 10 is also less prone to damage, thereby effectively extending the service life of the electrochemical apparatus and reducing the safety risk to the user in using the electrochemical apparatus (including but not limited to the lithium-ion battery or sodium-ion battery).

It can be understood that the structures in FIG. 1 to FIG. 17 are not necessarily drawn to scale and are only used for illustrative explanation of these embodiments of this application and should not be construed as any limitation on these embodiments of this application.

In summary, in these embodiment of this application, since the outer surface 11 of the housing 1 of the electrochemical apparatus 10 is provided with the first adhesive portion 3, and the contact angle of the surface of the first adhesive portion 3 facing away from the housing 1 is greater than 105°, when the housing 1 of the electrochemical apparatus 10 in this embodiment of this application is fixed to an electric device, at least a part of the housing 1 is less likely to be adhered by the electric device 4 or the adhesive structure on the electric device due to the presence of the first adhesive portion 3, so that when the electrode assembly 2 moves relative to the housing 1, that part of the housing 1 can undergo partial deformation with the movement of the electrode assembly 2. In this way, the impact of the electrode assembly 2 on that part of the housing 1 is buffered to some extent, thereby reducing the impact of the electrode assembly 2 on that part of the housing 1, so that the housing 1 is less prone to damage, and thus the electrochemical apparatus 10 is also less prone to damage, thereby effectively extending the service life of the electrochemical apparatus and reducing the safety risk to the user in using the electrochemical apparatus (including but not limited to the lithium-ion battery or sodium-ion battery).

According to another aspect of these embodiments of this application, referring to FIG. 17, an embodiment of this application provides an electric device 4 including: a device body 41; and the electrochemical apparatus 10 in any of the foregoing embodiments, where the electrochemical apparatus 10 is configured to supply power to the device body 41.

In some of these embodiments, referring to FIG. 3 to FIG. 7 and FIG. 14, the electric device 4 includes a second adhesive portion 42, and a peel strength (that is, the foregoing third peel strength) between the second adhesive portion 42 and the first adhesive portion 3 on the electrochemical apparatus 10 is less than a peel strength (that is, the foregoing second peel strength) between the second adhesive portion 42 and the outer surface 11 of the housing 1 of the electrochemical apparatus 10.

For the electric device 4 in these embodiments of this application, detailed descriptions have been provided in conjunction with some embodiments of the electrochemical apparatus 10 above. For relevant parts, reference can be made to the corresponding descriptions of the foregoing embodiments of the electrochemical apparatus 10, and details are not repeated herein.

Since the electric device 4 in these embodiments of this application includes the electrochemical apparatus 10 provided in some embodiments of this application, the electrochemical apparatus 10 of the electric device 4 is less prone to damage, has a better service life, can supply power more stably. Therefore, the electric device 4 also has a better service life and higher use safety for the user.

The term “includes” and its variations as used herein are open-ended terms meaning “including, but not limited to.” The term “based on” means “at least partially based on.” The term “an embodiment” means “at least one embodiment”; the term “another embodiment” means “at least one other embodiment”; and the term “some embodiments” means “at least some embodiments.” Relevant definitions of other terms will be given in the following description. It should be noted that, the concepts of “first,” “second,” and the like mentioned in this application are only used to distinguish different devices, modules, or units, and are not used to limit the sequence or interdependence of the functions performed by these devices, modules, or units.

It should be noted that, the modifiers “a,” “an,” and “multiple” mentioned in this application are indicative and not restrictive, and those skilled in the art should understand that, unless explicitly stated otherwise in the context, they should be understood as “one or more.”

Persons skilled in the art can easily figure out other implementation solutions of this application after considering the present specification and practicing the present invention applied herein. This application is intended to cover any variations, functions, or adaptive changes of this application. These variations, functions, or adaptive changes comply with general principles of this application, and include common knowledge or a commonly used technical means in the technical field that is not disclosed in this application. The specification and these embodiments are merely considered as examples, and the actual scope and the spirit of this application are indicated by the appended claims.

1. An electric device comprising:
a device body; and
an electrochemical apparatus comprising a housing, an electrode assembly disposed within the housing, and a first adhesive portion; wherein the housing is made of a metal plastic film, and the first adhesive portion is disposed on an outer surface of the housing; wherein the electrochemical apparatus is affixed to the device body, a first peel strength between the first adhesive portion and the device body is less than a second peel strength between the first adhesive portion and the outer surface of the housing.

2. The electric device according to claim 1, wherein the first adhesive portion is made of a material comprising at least one of silicon oxide, polysiloxane, or polytetrafluoroethylene.

3. The electric device according to claim 1, wherein at least one corner of the outer surface of the housing is provided with the first adhesive portion.

4. The electric device according to claim 3, wherein 2 to 4 corners of the outer surface of the housing are each provided with the first adhesive portion.

5. The electric device according to claim 1, wherein at least one side of each of the first adhesive portions fits with an edge of the outer surface of the housing.

6. The electric device according to claim 1, wherein the metal plastic film is an aluminum plastic film or a steel plastic film.

7. The electric device according to claim 1, wherein the first adhesive portion is of a plate-like structure.

8. The electric device according to claim 1, wherein the first peel strength is less than 180 gf/25 mm.

9. The electric device according to claim 8, wherein the first peel strength is greater than 0 gf/25 mm and less than or equal to 150 gf/25 mm.

10. The electric device according to claim 1, wherein a cross-sectional shape of the first adhesive portion is a sector or a closed figure; a radius R of the sector or the arc of the closed figure satisfies:
$$if W < L , 0.05 W \leq R \leq 0.35 W ; and$$
$$if W > L , 0.05 L \leq R \leq 0.35 L ;$$
wherein W is a width of the housing, and L is a length of the housing.

11. An electric device comprising:
a device body;
an electrochemical apparatus comprising a housing, an electrode assembly disposed within the housing, and a first adhesive portion; wherein the housing is made of metal plastic film, and the first adhesive portion is disposed on an outer surface of the housing; and
a second adhesive portion adhered to the device body and the electrochemical apparatus;
wherein the first adhesive portion overlaps with the second adhesive portion, and the first adhesive portion is adhered to the second adhesive portion; wherein a third peel strength between the second adhesive portion and the first adhesive portion is less than a second peel strength between the first adhesive portion and the outer surface of the housing.

12. The electric device according to claim 11, wherein the first adhesive portion is made of a material comprising at least one of silicon oxide, polysiloxane, or polytetrafluoroethylene.

13. The electric device according to claim 11, wherein at least one corner of the outer surface of the housing is provided with the first adhesive portion.

14. The electric device according to claim 11, wherein at least one side of each of the first adhesive portions fits with an edge of the outer surface of the housing.

15. The electric device according to claim 11, wherein the metal plastic film is aluminum plastic film or steel plastic film.

16. The electric device according to claim 11, wherein the first adhesive portion is of plate-like structure and the second adhesive portion is of plate-like structure.

17. The electric device according to claim 11, wherein the second adhesive portion is a double-sided adhesive.

18. The electric device according to claim 11, wherein the third peel strength is less than 180 gf/25 mm.

19. The electric device according to claim 18, wherein the third peel strength is greater than 0 gf/25 mm and less than or equal to 150 gf/25 mm.

20. The electric device according to claim 11, wherein a cross-sectional shape of the first adhesive portion is a sector or a closed figure; a radius R of the sector or the arc of the closed figure satisfies:
$$if W < L , 0.05 W \leq R \leq 0.35 W ; and$$
$$if W > L , 0.05 L \leq R \leq 0.35 L ;$$
wherein W is a width of the housing, and L is a length of the housing.
